(19) United States
(12) Patent Application Publication
(10) Pub. No.: US 2026/0339012 A1
(43) Pub. Date: Oct. 29, 2026

(54) FUNCTIONALISED WAVEGUIDE

(71) Applicant: Carl Zeiss Jena GmbH, Jena (DE)

(72) Inventors: Viktor SCHUETZ, Kahla (DE); Petr VOJTISEK, Jena (DE); Yi ZHONG-SCHIPP, Jena (DE)

(21) Appl. No.: 19/109,123

(22) PCT Filed: Sep. 8, 2023
(86) PCT No.: PCT/EP2023/074744

§ 371 Date: Mar. 5, 2025

(30) Foreign Application Priority Data
Sep. 8, 2022 (DE) 10 2022 122 789.8

(51) Int. Cl. F21V 8/00; G02B 1/11; G03H 1/02

(52) U.S. Cl. CPC G02B 6/0016; G02B 1/11; G03H 1/0248

(57) ABSTRACT

A functionalised waveguide has a transparent main body with a front side and a rear side. The main body has a coupling-in region and a coupling-out region spaced apart therefrom in a first direction. The coupling-in region comprises a diffractive structure which deflects at least a portion of the radiation, which comes from an object and strikes said structure, in such a manner that the deflected portion is propagated as coupled-in radiation in the main body through reflections up to the coupling-out region and strikes the coupling-out region. On the front side and/or rear side an anti-reflection layer is formed which transmits interference radiation, which would strike the diffractive structure only after a reflection on the front side and/or rear side, to the front side and/or rear side and thus suppresses the reflection on the front side and/or rear side.

### PRIORITY

This application claims the priority of German patent application DE 102022122789.8 filed Sep. 8, 2022, which is hereby incorporated herein by reference in its entirety.

### FIELD

The present invention relates to a functionalized waveguide, which can be used, for example, in a detector system or a screen.

### BACKGROUND

Transparent surfaces composed of glass or plastic such as, for example, windows or windshields in cars comprise a transparent base body and generally serve only to protect persons or objects against environmental influences such as wind, temperature, particles or radiation.

There has increasingly been an interest in making available such a transparent base body which provides an additional optical functionality.

### SUMMARY

An object of the invention to provide a transparent base body having an additional optical functionality.

In the functionalized waveguide according to certain embodiments, an anti-reflection layer, which suppresses a reflection of the interference radiation at the front side and/or rear side in particular owing to the interference radiation being transmitted on the front side and/or rear side, is formed on the front side and/or rear side. Thus, for example, undesirable ghost images (or double images) of the object or other undesirable effects of the interference radiation can be prevented or at least significantly reduced by means of the functionalized waveguide. Preferably 100% or at least 90% or more than 90%, 91%, 92%, 93%, 94%, 95%, 96%, 97%, 98% or 99% of the interference radiation is transmitted on the front side and/or rear side, thereby achieving the desired suppression of the reflection of the interference radiation at the front side and/or rear side.

In the transparent base body, a (e.g. partially transparent) input-coupling region and an output-coupling region spaced apart therefrom in a first direction may be provided or formed. The input-coupling region can comprise a diffractive structure used to maintain the transparency of the input-coupling region during normal viewing through it at a large angular and wavelength range. It is thus possible for only a portion of the radiation that is incident on a front side of the transparent base body to be deflected by means of the transparent input-coupling region such that the deflected portion propagates as input-coupled radiation in the base body through reflection to the output-coupling region and is incident on the output-coupling region.

The reflections can be in particular total internal reflections at the front side and/or rear side of the transparent base body. However, it is also possible for reflective layers or coatings or partly reflective layers or coatings to be provided for this purpose.

The front side and rear side of the transparent base body can be embodied as plane surfaces. In this regard, the transparent base body can be embodied as a plane-parallel plate, for example.

However, it is also possible for the front side and/or the rear side to be curved.

The transparent base body can be produced from glass and/or plastic. It can be in one piece or comprise a multilayered construction.

In particular, the transparent base body can be transparent to radiation or light from the visible wavelength range. Furthermore, a transparency to the near infrared and/or the infrared range can be present.

The output-coupling region of the transparent base body can deflect at least a portion of the input-coupled radiation that is incident on it such that the deflected portion emerges from the base body. This is preferably effected via the front side or rear side of the transparent base body.

The input-coupling region and the output-coupling region can be embodied such that they do not have an optical imaging function in addition to the deflection. However, it is also possible for the input-coupling region and/or the output-coupling region to provide an optical imaging function in addition to the deflection and thus to bring about optical imaging. Thus, the optical imaging function can realize for example the function of a converging lens or diverging lens, a concave or convex mirror, wherein the curved surfaces can be (centered or decentered) spherically curved or aspherically curved surfaces or free-form surfaces.

The diffractive structure of the input-coupling region can be realized as a buried diffractive structure, as a diffractive structure between two substrates, or as a diffractive structure formed on the front side or rear side.

Furthermore, the output-coupling region can comprise a diffractive structure. The diffractive structure of the output-coupling region can be realized as a buried diffractive structure or as a diffractive structure on the front side or rear side.

A reflective or transmissive volume hologram can be provided as a diffractive structure of the input-coupling region and/or of the output-coupling region. Furthermore, it is possible for the diffractive structure of the output-coupling and/or input-coupling region to be a transmissive or reflective relief grating.

If the input-coupling region is a (reflective or transmissive) relief grating, it is preferred not to form the anti-reflection layer directly on the relief grating. For example, the relief grating may be formed on the front side of the transparent base body and the anti-reflection layer on the rear side of the transparent base body (or vice versa).

If the input-coupling region is a (reflective or transmissive) volume hologram, the anti-reflection layer may be formed directly on the volume hologram. In particular, the volume hologram may be formed as a stack of a plurality of individual volume holograms, wherein each individual volume hologram is optimized for a predetermined wavelength. For example, three individual volume holograms can be optimized for wavelengths from the red, green, or blue wavelength range. If the volume hologram is embodied as a stack of a plurality of individual volume holograms, the anti-reflection layer is preferably formed as the first or last layer of such a stack.

The anti-reflection layer may preferably be designed such that it is transmissive (preferably only) for the predetermined wavelengths for which the diffractive structure (e.g. the volume hologram) of the input-coupling region is designed. Thus, the anti-reflection layer may have a transmissivity designed for the acceptance characteristic of the diffractive structure of the input-coupling region (or of the volume hologram or holograms). The acceptance characteristic is understood here in particular to mean that for a specific direction or specific angles of incidence there are specific wavelength spectra that are diffracted at the diffractive structure. In other words, the acceptance characteristic is understood here in particular to mean that the diffractive structure, depending on the angle of incidence, diffracts only specific wavelength spectra or only radiation of specific wavelengths.

Furthermore, it is possible that the anti-reflection layer is designed as a broadband anti-reflection layer, which is transmissive (preferably only) in the entire predetermined angle-of-incidence range for all the wavelengths used.

The anti-reflection layer may be formed as an individual layer or as a multi-layer system (for example as an interference layer system and/or as a moth-eye anti-reflection layer).

The anti-reflection layer may be designed for an angle-of-incidence range of 80 °-100 °, for example.

The anti-reflection layer may be formed in particular such that it does not influence the radiation coupled into the base body by the diffractive structure of the input-coupling region in such a way that it does not propagate through reflections to the output-coupling region. It can also be said that the optical properties, the dimensions, and/or positioning of the anti-reflection layer are selected in such a way that the radiation coupled into the base body by the diffractive structure of the input-coupling region can propagate through reflections to the output-coupling region.

For example, the dimensions and/or positioning of the anti-reflection layer can be selected such that the input-coupled radiation is not incident on the anti-reflection layer. This can be realized well, for example, in the case in which the anti-reflection layer is formed on the rear side of the base body and the diffractive structure of the input-coupling region is formed on the front side of the base body. Further, this can be readily achieved, for example, in the case in which the anti-reflection layer is formed on the front side of the base body and the diffractive structure of the input-coupling region is formed on the rear side of the base body. It is advantageous in this case, for example, if the dimension of the diffractive structure of the input-coupling region in the first direction lies in the range of 5 -15 mm or 5-10 mm. The dimension of the anti-reflection layer in the first direction may preferably be equal to or smaller than the dimension of the diffractive structure of the input-coupling region in the first direction.

Furthermore, it is advantageous if the dimension of the diffractive structure of the input-coupling region in the first direction is selected such that the radiation coupled into the base body by the diffractive structure of the input-coupling region after a first reflection in the base body is not again incident on the diffractive structure of the input-coupling region. This can be achieved, for example, by appropriately choosing the dimension of the diffractive structure of the input-coupling region in the first direction. For example, advantageous values range from 5 -15 mm or 5-10 mm.

The diffractive structure of the input-coupling region can be designed such that only the radiation that is coming from the object and is incident on the diffractive structure at an angle from a predetermined angle-of-incidence range is diffracted by the diffractive structure and thereby deflected, wherein the optical properties of the anti-reflection layer(s) are selected such that the anti-reflection layer(s) transmits/transmit radiation that is incident on the anti-reflection layer(s) at an angle that lies in the predetermined angle-of-incidence range.

It can also be said that the predetermined angle-of-incidence range defines a field of view. The anti-reflection layer(s) is/are preferably designed such that it is/they are transmissive at least for this field of view.

The predetermined angle-of-incidence range can be rotationally symmetric.

Alternatively, the predetermined angle-of-incidence range may not be rotationally symmetric. Thus, the predetermined angle-of-incidence range in a first plane (x-z plane), which is defined by a perpendicular on the diffractive structure and a vertical both to the first direction and to the perpendicular on the diffractive structure, is larger than in a second plane (y-z plane), which is defined by the perpendicular on the diffractive structure (12) and the first direction.

Preferably, the ratio is not greater than 2:1 or not greater than 3:2.

The predetermined angle-of-incidence range can lie, for example, in the range of 40 °to 120° and in particular be 40 °, 50 °, 60 °, 70 °, 80 °, 90 °, 100 °, 110 °or 120 °. In particular, the predetermined angle-of-incidence range may be symmetric with respect to the perpendicular on the diffractive structure. Thus, the predetermined angle-of-incidence range can be, for example, an arbitrary range of +/−20 ° to +/−60 ° and in particular a range of −20 °to 20 °, 25 °to 25 °, −30° to 30 °, −35 ° to 35 °, −40 °to 40 °, −45 °to 55 °, −50 °to 50 °,-55 °to 55 °or −60 °to 60 °.

The anti-reflection layer or the anti-reflection layers can be implemented in a wide variety of variants. First, the anti-reflection layer in the simplest form can be made from or consist of an individual layer, e.g. of MgF₂ (for example, on eyeglass lenses), and in more complex embodiments from/of a plurality of 10 to 100 layers, e.g. as in high-performance anti-reflective coatings on optics in ultra-short-pulsed lasers. Sample materials are TiO₂ and SiO₂. The anti-reflection layer can be planar and/or also implemented on additionally structured surfaces.

Examples include so-called moth-eye structures and/or pyramidal surfaces, such as those implemented on monocrystalline silicon solar cells, for example. Typically, adapted anti-reflection layers can be designed and optimized using software solutions known to a person skilled in the art.

Preferably, the anti-reflection layer completely covers the diffractive structure of the input-coupling region. For this purpose, the anti-reflection layer may have the same size as the diffractive structure or be larger (for example by 5-10%).

The output-coupling region can furthermore comprise a mirror surface, a prism, and/or a reflective or transmissive Fresnel structure. These variants can be provided as an alternative to the diffractive structure or in addition to the diffractive structure of the output-coupling region.

Furthermore, a detector system comprising a functionalized waveguide is provided. The detector system can comprise a detector, on which that portion of the radiation which is deflected by the output-coupling region is incident. The detector can be connected to the front side or the rear side of the base body. In particular, a direct connection can be present.

The detector system may be designed in particular as a camera, so that a recording (e.g. a single image, a plurality of images or a video) of the object can be effected.

Furthermore, the detector system can be embodied such that at least one optically imaging element is arranged in the region between the detector and the front side and/or rear side. It is also possible for the region between the detector and the front side and/or rear side to be free of imaging optical elements. In other words, the radiation coupled out from the output-coupling region is thus incident on the detector without having passed through further optically imaging elements. In this case, it is advantageous if the output-coupling region comprises an optically imaging property in addition to the deflection.

The functionalized waveguide can be embodied such that it carries out infinite-infinite imaging. However, it is also possible for said waveguide to carry out finite-infinite imaging, infinite-finite imaging or finite-finite imaging.

The detector system can, of course, also be embodied such that at least one optically imaging element is also arranged between the detector and the front side and/or rear side.

Furthermore, a projection system or a screen comprising a functionalized waveguide is provided. In particular, the functionalized waveguide can be arranged, for example, with the rear side of the transparent base body on a front side of a screen (e.g. connected thereto), so that light to be emitted from the screen via its front side for the presentation of a predetermined image enters the base body via the rear side thereof, travels to the front side of the base body, and exits via the front side of the base body. The anti-reflection layer, for example, transmits the portion of the light of the screen that is incident on the anti-reflection layer, thereby preventing undesirable stray light.

The system thus formed consisting of waveguide and screen can be designed, for example, as a stand-alone screen (e.g. a screen for a computer), as a laptop screen, as a mobile phone, as a tablet, etc.

The screen can be developed in such a way that the described detector system (in particular with the described camera functionality) is provided. This allows the object (e.g. a person looking at the screen) to be recorded. This can be realized, for example, in such a way that a person looking at the screen is recorded in such a way that they look into the eyes of the person shown on the screen with whom videotelephony (or a video conference) is carried out, for example, during the videotelephony, so that a natural impression is created during the videotelephony. It is essential herefor that the recording direction of the camera is, for example, vertical to the front side of the screen, which is possible with the screen due to the functionalized waveguide. This is advantageous for known solutions in which the camera is arranged at the periphery of the screen or in the screen frame, whereby a person looking at the screen is recorded obliquely from above, from below or from the side. This causes the well-known effect that the recorded person appears to look past a viewer.

In the region of the output-coupling region or section, the screen may, for example, not have any LCD elements (or other image-generating elements) or is designed, for example, to be transparent. In particular, the output-coupling region or section may lie in a region in which no image information is generated by the screen. It is also possible that no part of the screen is formed in the region of the output-coupling region or section. This can, for example, ensure that the portion of the input-coupled radiation deflected by the output-coupling region is incident on the detector.

It goes without saying that the features mentioned above and the features yet to be explained hereinafter can be used not only in the specified combinations but also in other combinations or on their own, without departing from the scope of the present invention.

The invention will be explained in even greater detail below on the basis of exemplary embodiments with reference to the accompanying drawings, which likewise disclose features essential to the invention. These exemplary embodiments are used for illustration only and should not be construed as limiting. For example, a description of an exemplary embodiment having a multiplicity of elements or components should not be construed as meaning that all these elements or components are necessary for implementation. Rather, other exemplary embodiments may also contain alternative elements and components, fewer elements or components, or additional elements or components. Elements or components of different exemplary embodiments can be combined with one another, unless stated otherwise.

Modifications and variations that are described for one of the exemplary embodiments can also be applicable to other exemplary embodiments. In order to avoid repetition, elements that are the same or correspond to one another in different figures are denoted by the same reference signs and are not explained repeatedly.

### BRIEF DESCRIPTION OF THE DRAWINGS

FIG. 1 shows a side view of one embodiment of a detector system according to the invention;

FIG. 2 shows a plan view of the waveguide from FIG. 1;

FIG. 3 shows a schematic illustration of the spectrally resolved, angle-dependent deflection efficiency of the transmissive volume hologram of the input-coupling region;

FIG. 4 shows a schematic illustration of the deflection efficiency for three different angles of incidence as a function of wavelength;

FIG. 5 shows a side view of a detector system with a waveguide without an anti-reflection layer;

FIG. 6 shows a schematically enlarged illustration of the input-coupling region of the side view of FIG. 5;

FIG. 7 shows a side view of a further embodiment of the detector system according to the invention;

FIG. 8 shows a side view of a detector system with a waveguide without an anti-reflection layer;

FIG. 9 shows a side view of a further embodiment of the detector system according to the invention, and

FIG. 10 shows a side view of a further embodiment of the detector system according to the invention.

### DETAILED DESCRIPTION

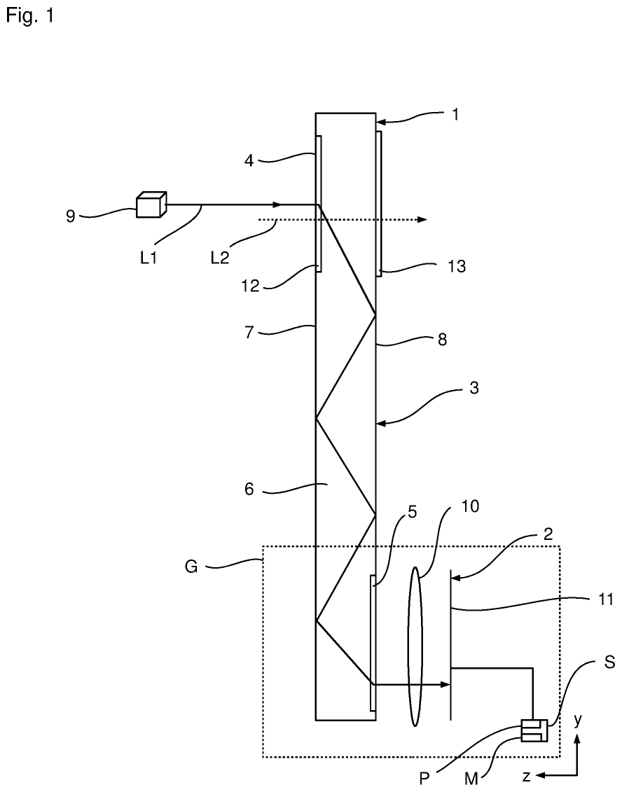

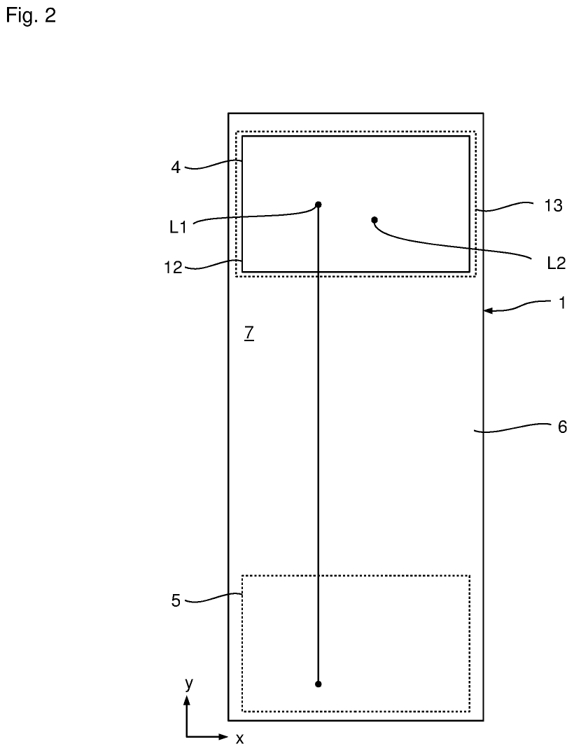

The views in accordance with FIGS. 1 and 2 show an embodiment of the waveguide 1 together with a detector system 2 in order to implement a camera 3.

For this purpose, the waveguide 1 comprises an input-coupling region 4 and an output-coupling region 5 spaced apart therefrom in a first direction (here along the y-axis) and can be embodied as a plane-parallel plate 6 having a plane front side 7 and a plane rear side 8. The plane-parallel plate 6, which can also be referred to as a base body 6, is formed from a transparent material, such as e.g. glass or plastic.

The detector system 2 and the lower part of the plate 6 with the output-coupling region 5 can be arranged in a housing G, which is merely illustrated schematically in FIG. 1, such that at first glance it is not evident to a user that this is a camera 3. In the housing, a control unit S may be provided, which can control the performance of a recording, and for example comprises a processor P and a memory M.

By means of the camera 3, an object 9 can be imaged in such a way that light beams emanating from the object 9 (a light ray L1 is shown as a representative) enter the plate 6 via the front side 7 and are deflected by the input-coupling region 4 such that they are incident on the rear side 8 at an angle such that total internal reflection takes place. The light beams L1 are thus guided as far as the output-coupling region 5 by means of total internal reflection at the front side 7 and rear side 8, said output-coupling region bringing about a deflection in a direction toward the rear side 8, such that the light beams L1 emerge from the plate 6 via the rear side 8. Of course, it is also possible to coat the front side and rear side 7, 8 with a reflective or partially reflective coating (not shown in FIGS. 1 and 2), so that the guidance of the light beams in the plate 6 from the input-coupling to the output-coupling region 4, 5 takes place by reflections at the reflective or partially reflective coating.

By means of an objective 10 of the detector system 2, the light beams L1 are then focused onto a detector 11 of the detector system 2, such that the desired image of the object 9 can be recorded by means of the detector 11. In FIG. 1, the illustration with respect to the imaging properties of the objective 10 is purely schematic. The detector system 2 can also be designed such that no objective 10 is required. For example, it is possible that the output-coupling region 5 provides a desired imaging function (in addition to the beam deflection).

The input-coupling region 4 may, for example, have a transmissive volume hologram 12, which has an incidence-angle-dependent wavelength selectivity, so that it has a high transparency for a large angle and wavelength range. That means that only a portion of the light beams L1 emanating from the object 9 and incident on the input-coupling region 4 (or on the transmissive volume hologram 12) are deflected in the manner described. Other light beams from the object 9 propagate through the input-coupling region 4 (or through the transmissive volume hologram 12) and emerge from the plate 6 via the rear side 8. The input-coupling region 4 can thus be designated as being partially transparent.

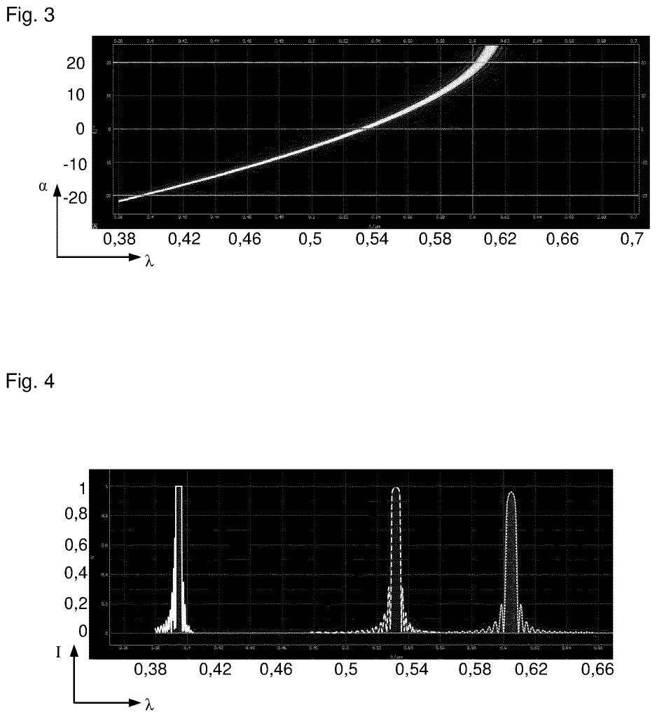

FIG. 3 schematically illustrates the spectrally resolved, angle-dependent deflection efficiency for the transmissive volume hologram 12 of the input-coupling region 4 as a function of the angle of incidence (in the y-z plane) of the corresponding light beam, wherein the wavelength in um is plotted along the x-axis and the angle of incidence in °is plotted along the y-axis. FIG. 4 illustrates the deflection efficiency for the angles of incidence +20 °, 0 °and −20 °, wherein the wavelength in nm is plotted along the x-axis and the efficiency is plotted along the y-axis.

It can be gathered from FIGS. 3 and 4 that the transmissive volume hologram 12 of the input-coupling region 4, for an angle of incidence of −20 °, deflects radiation from the spectral range of 392 nm to 398 nm (λ_{zentral}=395 nm +3 nm) with high efficiency and thus couples it into the plane-parallel plate 6. For an angle of incidence of 0 °the high efficiency is present for the spectral range of 528 nm to 536 nm (λ_{zentral}=532 nm +4 nm), and for the angle of incidence of +20 °there is a high input-coupling efficiency for the spectral range of 600 nm to 610 nm (λ_{zentral}=605 nm±5 nm).

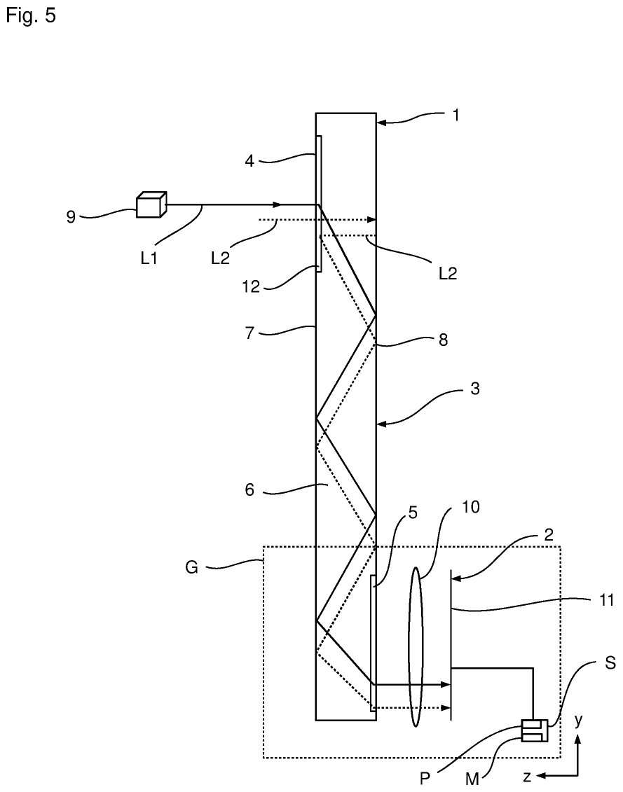

The input-coupling region 4 additionally has an anti-reflection layer 13 (FIGS. 1 and 2), which is designed in such a way that it transmits light beams (a light beam L2 is shown as a representative) which, for example, emanate from the object 9 and would result in an undesired ghost image at the detector 11, such that they emerge from the plate 6 via the rear side 8 and therefore cannot be incident on the detector 11. Without the anti-reflection layer 13, a portion of the light beams L2 at the interface rear side 8—air would be reflected back toward the front side 7, as schematically illustrated in FIG. 5. To simplify the illustration, the reflected-back portion of the light beams is drawn offset in the y-direction in FIG. 5.

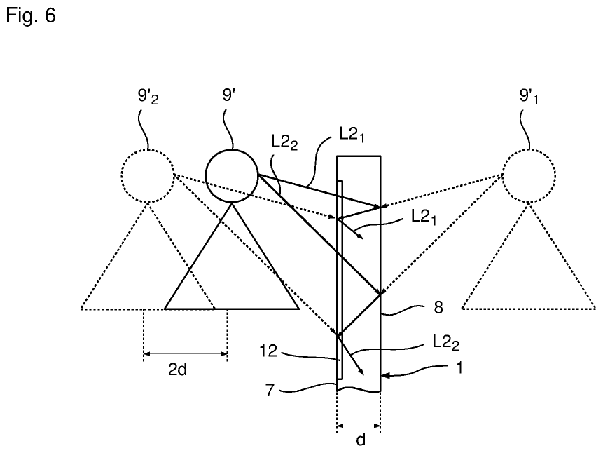

From this reflected-back portion of the light beams L2, which in the embodiment of the waveguide in FIG. 5 is incident on the volume hologram 12, a specific proportion is reflected at the interface air—front side 7 and deflected by the volume hologram 12, as is schematically shown in FIG. 6. This deflected portion of the light beams L2 is then guided in the same manner as the deflected portion of the light beams L1 to the output-coupling section 5 and output-coupled, so that an unwanted ghost image is generated.

FIG. 6 shows schematically enlarged for an object 9′ how the undesired ghost image may arise. Light beams L2₁ and L2₂ pass through the volume hologram 12 (without being deflected), are reflected at the interface air—rear side 8 (a first virtual image 9′₁ is generated by the reflection at the interface air—rear side 8), pass once again through the volume hologram 12, are reflected at the interface air-front side 7 (a second virtual image 9′₂ is generated by the reflection at the interface air-front side 7) and are then deflected by the volume hologram 12 such that they are guided in the plate 6 to the output-coupling region 5. These light beams L2₁ and L2₂ thus generate a second virtual image 9′₂, which appears as a ghost image offset from the object 9′ by twice the distance d from the front side 7 to the rear side 8.

By providing the anti-reflection layer 13 according to FIGS. 1 and 2, such an unwanted ghost image is greatly reduced, since by means of the anti-reflection layer 13 (FIG. 1) the light beams L2, L2₁ and L2₂ are transmitted and thus no longer reflected at the interface air-rear side 8.

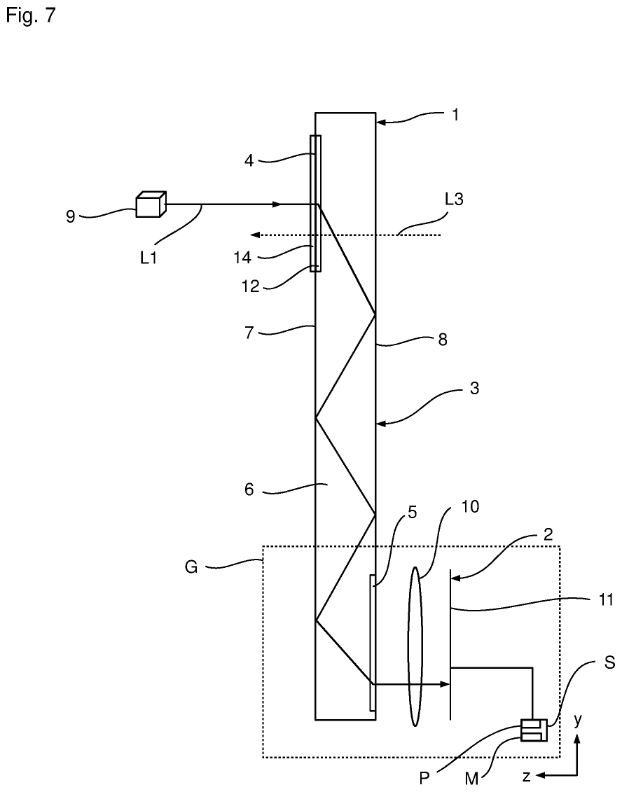

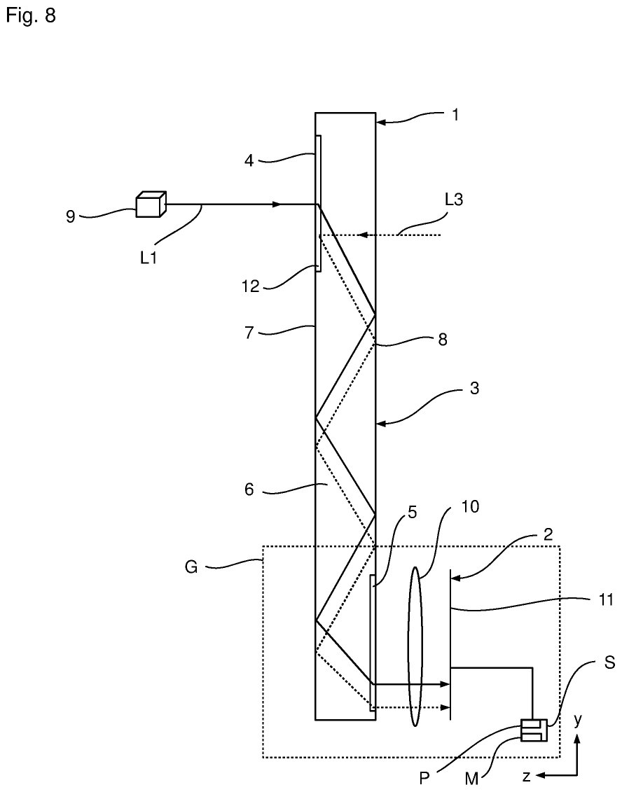

FIG. 7 shows a modification of the embodiment according to FIGS. 1 and 2. In the embodiment of FIG. 7, an anti-reflection layer 14 is formed on the front side 7 in front of the volume hologram 12. This prevents unwanted ghost images that may originate from light beams (a light beam L3 is drawn as a representative) that enter the plate 6 via the rear side 8 and pass through the volume hologram 12. A portion of these light beams would then be reflected at the interface front side 7—air (as schematically illustrated in FIG. 8) and be incident again on the volume hologram 12, which would deflect a portion of it in the manner shown in FIG. 8, whereby this light would be guided in the plate 6 to the output-coupling section 5 and output-coupled by means of the output-coupling section 5 and would lead to the undesired ghost image. However, due to the anti-reflection layer 14 on the front side 7, the light beams L3 are transmitted (FIG. 7), so that such ghost images can be prevented.

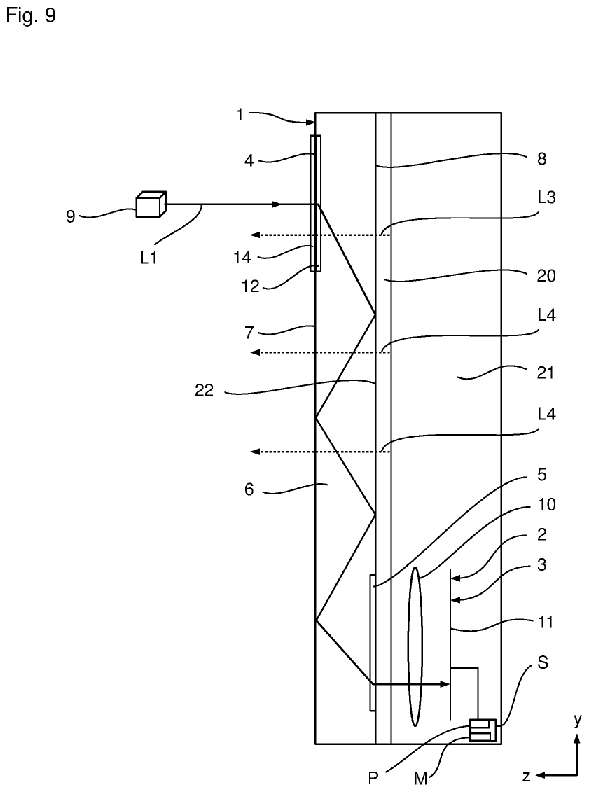

In the embodiment shown in FIG. 9 of the waveguide 2, the latter is applied to a screen 20, which is located in a housing 21, in which the detector system 2 is also disposed. The system thus formed can be designed e.g. as a stand-alone screen (e.g. a screen for a computer), a laptop screen, a mobile phone, a tablet, etc. The illustration in FIG. 9 is purely schematic and in particular not true to scale.

The rear side 8 of the base body 6 is connected to a front side 22 of the screen 20 (e.g. by adhesive bonding), so that for generating a predetermined image on the screen 20 the light (L3, L4) emitted from the screen 20 via its front side 22 enters the transparent base body 6 through the rear side 8, travels in the base body to the front side 7 and exits via the front side 7, such that a viewer can perceive the image generated by the screen 20. This light L3, L4 emitted by the screen 20 could, for example, lead to undesired stray light in the region of the input-coupling region 4. However, since the anti-reflection layer 14 is provided, the light beams L3 which could result in stray light are transmitted and thus emerge from the base body 6 via the front side 7. Thus, the light emitted by the screen 20 does not lead to any unwanted stray light and there is no undesirable reduced brightness in the image generated by the screen 20 in the region of the input-coupling region 4.

In the region of the output-coupling section 5, the screen 20, for example, has no LCD elements or is transparent, for example, so that the light beams L1 deflected by the output-coupling section 5 can be focused by the objective 10 onto the detector 11. Thus, the output-coupling section 5 may lie in a region in which no image information is generated by the screen 20 (it should be noted that the illustration in FIG. 9 is schematic and not true to scale).

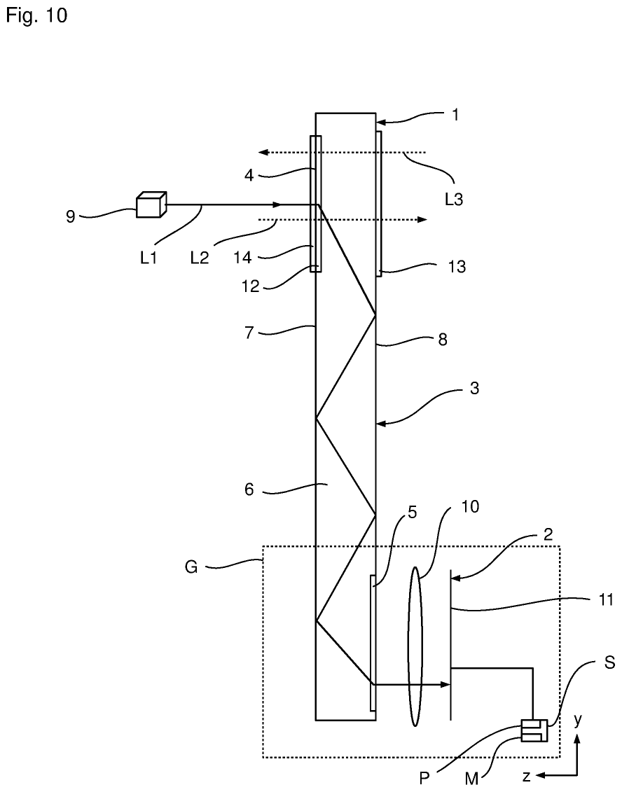

In FIG. 10, a modification of the embodiment according to FIGS. 1 and 2 is shown, in which in addition to the anti-reflection layer 13 an anti-reflection layer 14 according to FIG. 4 is provided, so that suppression of unwanted ghost images due to light beams L2 and L3 can be prevented.

The light beams L2, L3 shown in FIGS. 1, 2, 7, 9 and 10 are incident on the front side 7 and rear side 8 vertical with respect to one another. Of course, the anti-reflection layers 13, 14 can be designed for a predetermined angle-of-incidence range of the light beams L2, L3. This predetermined angle-of-incidence range can be, for example, 80 °-100 °. The angle of incidence is understood here to mean in particular the angle of the light beam L2 to the perpendicular on the front side (i.e. 0 °in FIG. 1) or the angle of the light beam L3 to the perpendicular on the rear side (i.e. 0 °in FIG. 7) in the respective y-z plane (hereinafter also referred to as the second plane). The angle-of-incidence range in the x-z plane (hereinafter also referred to as the first plane) may be equal in size to (in which case there is a rotationally symmetric angle-of-incidence range) or be greater than the angle-of-incidence range in the y-z plane, wherein a ratio of no greater than 2:1 or 3:2 can be present. The predetermined angle-of-incidence range is preferably symmetrical with respect to the respective perpendicular, so that in a predetermined angle-of-incidence range of e.g. 80 °, the range from −40 °to 40 °is covered.

The waveguide 1 according to FIGS. 1, 2, 7, 9 and 10 can be designed such that neither the input-coupling region 4 nor the output-coupling region 5 has an imaging function. In this case, the configuration of the waveguide 1 is an infinite-infinite configuration. It can also be stated that the waveguide 1 carries out infinite-infinite imaging. The detector 11 can be e.g. a CCD detector or a CMOS detector.

Since the input-coupling region 4 comprises the transmissive volume hologram 12, the input coupling by means of the transmissive volume hologram 12 leads to dispersion within the input-coupled spectral range for each angle. If the output-coupling region 5 comprises a transmissive volume hologram embodied in the same way as the input-coupling region 4, the dispersion caused by the input-coupling region 4 is compensated for and all spectral components are deflected again into the corresponding angle.

As an alternative to the described infinite-infinite configuration of the waveguide 1, the input-coupling region 4 and/or the output-coupling region 5 can have e.g. an imaging function in the form of a lens function or concave mirror function. As a result, finite-infinite, infinite-finite or finite-finite imaging configurations can be realized by means of the waveguide 1. In the case of the input-coupling region 4, this can be used for example to record an object 9 which is positioned so close to the waveguide 1 that it is no longer possible to optically consider it an object infinitely far away. In the case of the output-coupling region 5, an implementation of such a lens function or concave mirror function makes it possible to convert the output-coupled angular spectrum directly into a local distribution in the focal plane of this implemented lens function or mirror function. In this case, the objective 10 can be omitted, for example. In this case, it can be stated that the detector system 2 comprises the detector 11 and also the lens function and/or concave mirror function of the output-coupling region 5. Since the objective 10 can be omitted, the detector 11 can be positioned and/or secured for example directly on the rear side 8 of the waveguide 1, as a result of which a very high degree of integration, a minimum volume and high robustness can be realized.

The described reflective volume holograms for the input-coupling region 4 and the output-coupling region 5 can be produced for example such that a photosensitive volume-holographic material 12 integrated into the waveguide 1 is exposed with a reference wave having the wavelength of 532 nm, which is incident on the front side 7 at an angle of incidence of 0 °, and a signal wave having the same wavelength, which is incident on the rear side 8 at an angle of incidence of 60 °, wherein the reference wave and the signal wave originate from the same laser, such that an interference field or interference volume arises via the photosensitive volume-holographic material and corresponding refractive index modifications can form there.

Photosensitive glasses, dichromate gelatins or photopolymers can be used as photosensitive volume-holographic materials. They can e.g. be applied to a PC film (polycarbonate film) and be correspondingly exposed there. The film can then be laminated onto a substrate for the waveguide 1 in order to produce the waveguide 1. In this case, the film can be laminated for example only in the regions of the input-coupling region 4 and of the output-coupling region 5. Alternatively, whole-area lamination over the entire waveguide surface is possible, wherein only the corresponding input-coupling and output coupling function is introduced by exposure into the input-coupling and output-coupling regions. In order to protect the volume holograms, it is expedient to apply a further substrate to the laminated volume hologram. A layer stack having the following basic construction is thus realized: transparent substrate, cement or adhesive layer, volume hologram, cement or adhesive layer, transparent substrate.

While the invention has been described in connection with what is presently considered to be the most practical and preferred embodiments, it will be apparent to those of ordinary skill in the art that the invention is not to be limited to the disclosed embodiments. It will be readily apparent to those of ordinary skill in the art that many modifications and equivalent arrangements can be made thereof without departing from the spirit and scope of the present disclosure, such scope to be accorded the broadest interpretation of the appended claims so as to encompass all equivalent structures and products. Moreover, features or aspects of various example embodiments may be mixed and matched (even if such combination is not explicitly described herein) without departing from the scope of the invention.

1-17. (canceled)

18. A functionalized waveguide, comprising:
a transparent base body with a front side and a rear side, the base body comprising an input-coupling region and an output-coupling region spaced apart therefrom in a first direction,
wherein the input-coupling region comprises a diffractive structure, which deflects at least a portion of radiation which is coming from an object and is incident on the input-coupling region in a manner such that the deflected portion propagates as input-coupled radiation in the base body through reflections to the output-coupling region and is incident on the output-coupling region, which deflects at least a portion of the input-coupled radiation that is incident on the output-coupling region such that the deflected portion emerges from the base body,
wherein an anti-reflection layer is formed on the front side and/or the rear side, which transmits the stray radiation, which would be incident on the diffractive structure only after a reflection at the front side and/or the rear side, on the front side and/or the rear side, and thus suppresses the reflection at the front side and/or the rear side.

19. The functionalized waveguide of claim 18, wherein a first anti-reflection layer is formed on the front side.

20. The functionalized waveguide of claim 18, wherein a second anti-reflection layer is formed on the rear side.

21. The functionalized waveguide of claim 18, wherein the anti-reflection layer completely covers the diffractive structure.

22. The functionalized waveguide of claim 18,
wherein a first anti-reflection layer is formed on the front side,
wherein a second anti-reflection layer is formed on the rear side, and
wherein the first anti-reflection layer and/or the second anti-reflection layer are/is configured to transmit the radiation coming from the object to be detected.

23. The functionalized waveguide of claim 18, wherein the diffractive structure is a transmissive or reflective volume hologram.

24. The functionalized waveguide of claim 18, wherein the optical properties, the dimensions, and/or positioning of the anti-reflection layer(s) are selected such that the radiation coupled into the base body by the diffractive structure of the input-coupling region can propagate through reflections to the output-coupling region.

25. The functionalized waveguide of claim 18, wherein the dimension of the diffractive structure of the input-coupling region in the first direction is selected such that the radiation coupled into the base body by the diffractive structure of the input-coupling region is not incident again on the diffractive structure of the input-coupling region after a first reflection in the base body.

26. The functionalized waveguide of claim 18,
wherein the diffractive structure of the input-coupling region is configured such that only the radiation which is coming from the object and which is incident on the diffractive structure at an angle from a predetermined angle-of-incidence range is deflected by the diffractive structure, and
wherein the optical properties of the anti-reflection layer(s) are selected such that the anti-reflection layer(s) transmit/transmits radiation that is incident on the anti-reflection layer(s) at an angle that lies in the predetermined angle-of-incidence range.

27. The functionalized waveguide of claim 26, wherein the predetermined angle-of-incidence range is rotationally symmetric.

28. The functionalized waveguide of claim 26,
wherein the predetermined angle-of-incidence range in a first plane defined by a perpendicular on the diffractive structure and a vertical both to the first direction and to the perpendicular on the diffractive structure is greater than in a second plane which is defined by the perpendicular on the diffractive structure and the first direction, and
wherein a ratio of not greater than 2:1 or 3:2 is present.

29. The functionalized waveguide of claim 18, wherein the anti-reflection layer is transmissive for the predetermined wavelengths for which the diffractive structure of the input-coupling region is designed.

30. The functionalized waveguide of claim 18, wherein the anti-reflection layer is formed such that it has a transmissivity designed for the acceptance characteristic of the diffractive structure of the input-coupling region.

31. The functionalized waveguide of claim 18, wherein the anti-reflection layer is formed such that it is transmissive for all wavelengths used in the entire predetermined angle-of-incidence range of the diffractive structure of the input-coupling region.

32. A detector system, comprising the functionalized waveguide of claim 18.

33. The detector system of claim 32, further comprising a detector, on which the portion of the radiation which is deflected by the output-coupling region is incident.

34. The detector system of claim 32,
further comprising a screen having a front side, which can radiate light via the front side to present an image,
wherein the base body with its rear side is mounted on the front side of the screen so that the light coming from the screen passes through the base body and exits via the front side of the base body, and
wherein the portion of the light coming from the screen which is incident on the anti-reflection layer is transmitted by the latter.
